(19) United States
(12) Patent Application Publication
(10) Pub. No.: US 2014/0152530 A1
(43) Pub. Date: Jun. 5, 2014

(54) MULTIMEDIA NEAR TO EYE DISPLAY SYSTEM

(71) Applicant: HONEYWELL INTERNATIONAL INC., Morristown, NJ (US)

(72) Inventors: Sharath Venkatesha, Golden Valley, MN (US); Kwong Wing Au, Bloomington, MN (US)

(73) Assignee: Honeywell International Inc., Morristown, NJ (US)

(21) Appl. No.: 13/692,509

(22) Filed: Dec. 3, 2012

(51) Int. Cl. G09G 3/00

(52) U.S. Cl. CPC G09G 3/001
USPC 345/8

(57) ABSTRACT

A system and method include receiving video images based on field of view of a wearer of a near to eye display system, analyzing the video images to identify an object in the wearer field of view, generating information as a function of the identified objects, and displaying the information on a display device of the near to eye display system proximate the identified object.

### BACKGROUND

Near to Eye (NTE) displays (also referred to as NED in some literature) are a special type of display system which when integrated to an eye wear or goggles, allows the user to view a scene (either captured by a camera or from an input video feed) at a perspective such that it appears to the eye as watching a high definition (HD) television screen at some distance. A variant of the NTE is a head-mounted display or helmet mounted display, both abbreviated HMD. An HMD is a display device, worn on the head or as part of a helmet, that has a small display optic in front of one (monocular HMD) or each eye (binocular HMD).

Personal displays, visors and headsets require the user to wear the display close to their eyes, and are becoming relatively common in research, military and engineering environments, and high-end gaming circles. Wearable near-to-eye display systems for industrial applications have long seemed to be on the verge of commercial success, but to date, acceptance has been limited. Developments in micro display and processor hardware technologies have made possible NTE displays to have multiple features, hence making them more user acceptable.

### SUMMARY

A method includes receiving video images based on fields of view of a near to eye display system, applying video analytics to enhance the video images and to identify regions of interest (ROI) on the video images, generating user assistance information as a function of at least one characteristic of the regions of interest, and augmenting the enhanced video with the derived information proximate to corresponding regions of interest via visual displays and audio of the near to eye display system.

A near to eye display device and method include receiving video images from one or more cameras based on field of view of a wearer of a near to eye display system, analyzing the video images generating information as a function of the scene and displaying the information on a display device of the near to eye display system proximate to regions of interest derived as a function of the video analytics.

A system includes a frame supporting one or a pair of micro video displays near to an eye of a wearer of the frame. One or more micro video cameras are supported by the frame. A processor is coupled to receive video images from the cameras, perform general video analytics on the scene in the field of view of the cameras, generate information as a function of the scene, and display the information on the video display proximate the regions of interest.

### BRIEF DESCRIPTION OF THE DRAWINGS

FIG. 1 is a perspective block diagram of a near to eye video system according to an example embodiment.

FIG. 2 is a diagram of a display having objects displayed thereon according to an example embodiment.

FIG. 3 is a flow diagram of a method of displaying objects and information on a near to eye video system display according to an example embodiment.

FIG. 4 is a block schematic diagram of a near to eye video system according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, other type of an embedded processor, or a remote computer system, such as a personal computer, server or other computer system with a high computing power.

A near-to-eye (NTE) display system coupled with a micro camera and processor has the capability to perform video analytics on the live camera video. The results from the video analytics may be shown on the NTE via text and graphics. The same information can be provided to a user by an audio signal via headphones connected to the system. The user, when presented with the results in real-time, will have a greater ability in decision making. For example, if the NTE display system runs a face recognition analytics on the scene, the wearer/user will be able to obtain information on the person recognized by the system. Similarly, such a system with multiple cameras can be used to perform stereo analytics and infer 3D information from the scene.

The embodiments described below consider a set of additional hardware and software processing capabilities on the NTE. A frame containing the system has two micro displays, one for each eye of the user. The system is designed having one or more micro-cameras attached to the goggle frame, each of which capture live video. The cameras are integrated with the NTE displays and the micro displays show the processed video feed from multiple cameras on the screen. The display is not a see through display in some embodiments. The wearer views the NTE displays. References to the field of view of the wearer or system refer to the field of view of processed video feed from the multiple cameras attached to the NTE system. Hence, the wearer looks at the world through the cameras.

A processor with video and audio processing capabilities is added to the system and is placed in the goggle enclosure, or is designed to be wearable or be able to communicate to a remote server. The processor can analyze the video feed; perform graphics processing, process, and generate audio signals. Remote input devices may be integrated into the system. For example, a microphone may be included to detect oral user commands. Another input device may be a touch panel.

A set of headphone speakers may be attached to output the audio signals. The NTE system is connected to processor via wired or wireless communication protocols like Bluetooth, wi-Fi, etc. Reference to NTE display refers to a multimedia system which consists of a NTE display with cameras, processors, microphones and speakers.

In one embodiment, the processor is designed to perform video analytics on the live input feed from one or more cameras. The video analytics include, but are not limited to dynamic masking, ego motion estimation, motion detection, object detection and recognition, event recognition, video based tracking etc. Relevant biometrics including face recognition can be implemented on the processor. Other implementations for the industrial domain include algorithms designed to infer and provide essential information to the operator. For example, methods include identifying tools, and providing critical information such as temperature, rotations per minute of a motor, or fault detection etc which are possible by video analysis.

In one embodiment, the processor is programmed to perform a specific type of video analytics, say face recognition on the scene. In another embodiment, the user selects the specific type of scene analysis via a touch based push button input device connected to the NTE system. In a further embodiment, the user selects the video analysis type through voice commands. A microphone connected to the system recognizes the user command and performs the analysis accordingly.

In one embodiment, video is displayed with video analytics derived information as video overlay. Text and graphics are overlaid on the video to convey to the user. The overlaid graphics include use of color, symbols and other geometrical structures which may be transparent, opaque or of multiple semi-transparent shading types. An example includes displaying an arrow pointing to an identified object in the scene with the object overlaid with a semi-transparent color shaded rectangle. The graphics are still or motion-gif based. Further, other required instructions to perform a task and user specific data are displayed as onscreen text. Such an overlay or on micro-screen display enables a hands free experience enabling better productivity. In further embodiments, the area (or region of interest) in which the information overlay is done is identified via image processing. The information may be placed near the areas of interest giving rise to the information, e.g. proximate an object detected in the scene.

In another embodiment, the information to be displayed is stored data in memory or derived via a query on the World Wide Web. For example, face recognition algorithm implemented on the NTE system detects and recognizes a face in the field of view of the camera. Further, it overlays a rectangular box on the face and shows the relevant processed information derived from the internet, next to the box. In an industrial scenario, the NTE device can be used for operator training, where the system displays a set of instructions on screen.

In one embodiment, the information overlay is created by processing the input video stream and modifying the pixel intensity values. In other embodiments, a transparent LCD or similar technology for text display over LCD/LCoS/Light-Guide-Optics (LOE) video display systems is used.

In one embodiment, the results of the video analytics performed by the system are provided to the user as audio. The results of the analysis are converted to text and the processor has a text to speech converter. The audio output to the user is via a set of headphones connected to the system. In a further embodiment, the processor selects and plays back to the user, one or a set of the pre-recorded audio commands, based on the video analysis.

In one embodiment, two or more cameras are arranged on the system frame as a stereo camera pair and are utilized to derive depth or 3D information from the videos. In a further embodiment, the derived information is overlaid near objects in the scene, i.e., the depth information of an object is shown on screen proximate to the object. One application includes detecting a surface abnormality and/or obstacles in the scene using stereo imaging and placing a warning message near the detection to alert the user when walking. Further information may include adding a numerical representation of a distance to an object and display information on screen. In yet further embodiments, a geometric object of a known size is placed near an object to give the user a reference to gauge the size of the unknown object.

In one embodiment, the combined 2D and 3D information is displayed on the screen. 3D depictions which minimize the interpretative efforts needed to create a mental model of the situation are created and displayed on screen. An alternative embodiment processes the 3D information onboard a processor and provides cues to the wearer as a text or audio based information. This information can be depth, size etc of the objects in the scene, which along with a stereoscopic display will be effective for enhanced user experience.

In one embodiment, image processing is done in real time and the processed video is displayed on screen. The image processing includes image color and intensity correction on the video frames, rectification, image sharpening and blurring, among others for enhanced user experience. In one embodiment, the NTE systems provide the ability to view extremely bright sources of light such as lasers. The image processing feature in this scenario reduces the local intensity of light when viewed through a NTE display system.

In one embodiment, the cameras in the system may be receptive to different spectra including visible, near infrared (NIR), ultraviolet (UV) or other infrared bands. The processor will have capability to perform fusion on images from multi-spectral cameras and perform the required transformation to display output to the near-to-eye display.

In a further embodiment, a sensor such as a MEMS accelerometer and/or camera viewing the user eye to provide orientation of the frame and images of the eye of the user including a pupil position are provided. Eye and pupil position are tracked using information from the sensor. The sensor provides information regarding where the user is looking, and images to be displayed are processed based on that information to provide a better view.

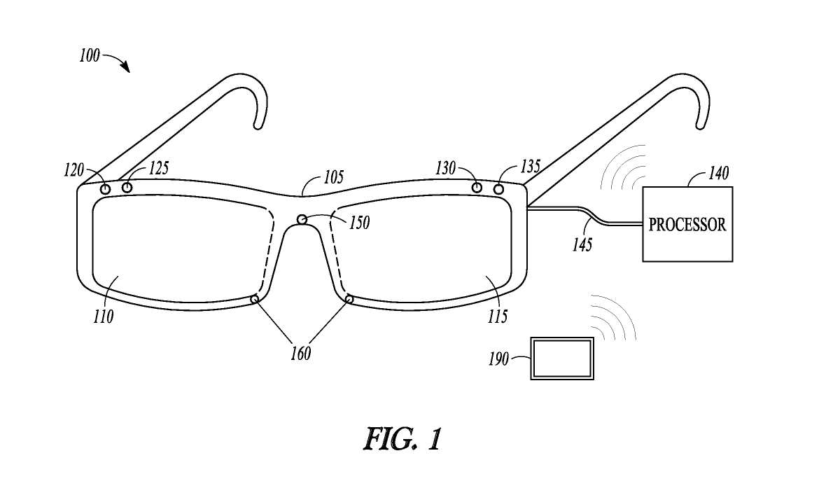

FIG. 1 is a perspective block diagram representation of a multimedia near to eye display system 100. System 100 includes a frame 105 supporting a video display or displays 110, 115 near one or more eyes of a wearer of the frame 105. A display may be provided for each eye, or for a single eye. The display may even be a continuous display extending across both eyes.

At least one video camera 120, 125, 130, 135 is supported by the frame 105. Micro type cameras may be used in one embodiment. The cameras may be placed anywhere along the frame or integrated into the frame. As shown, the cameras are near the outside portions of the frame which may be structured to provide more support and room for such camera or cameras.

A processor 140 coupled via line 145 to receive video images from the camera 120, 125, 130, 135 and to analyze the video images to identify an object in the system field of view. A MEMS sensor 150, shown in a nose bridge positioned between the eyes of a wearer in one embodiment, provides orientation data. The processor performs multiple video analytics based on a preset or specific user command. The processor generates information as a function of the video analytics, and displays the information on the video display proximate the region of interest. In one embodiment, the analytics may involve object detection. In various embodiments, the information includes text describing a characteristic of the object, or graphical symbols located near or calling attention to an object. The processor 140 may be coupled to and supported by the frame 105, or may be placed remotely and supported by clothing of a wearer. Still further, the line 145 is representative of a wireless connection. When further processing power is needed, the processor 140 may communicate wirelessly with a larger computer system.

A microphone 160 may be included on the frame to capture the user commands. A pair of speaker headphones 170, 180 may be embedded to the frame 105, or present as pads/ear buds attached to the frame. The processor 140 may be designed to perform audio processing and command recognition on the input from microphone 160 and drive an audio output to the speaker headphones 170, 180 based on methods described in earlier embodiments. In some embodiments, a touch interface or a push button interface 190 is also present to accept the user commands.

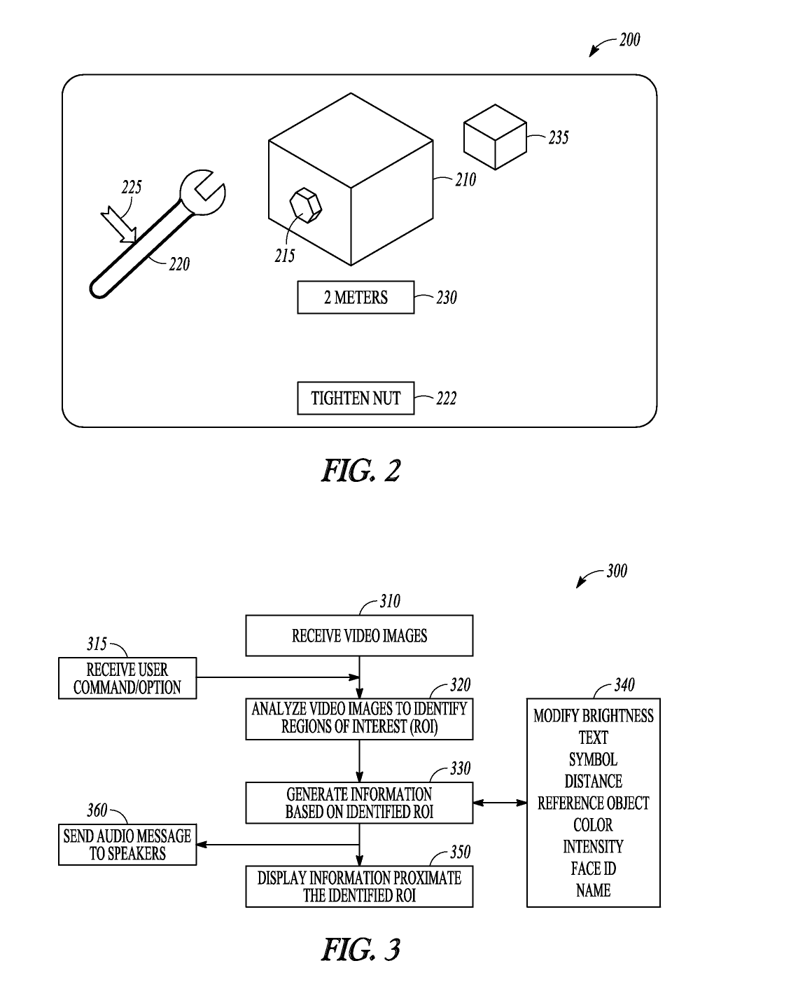

FIG. 2 is a block representation of a display 200 having one or more images displayed. The block representation considers a specific example of video analytics performed on the scene, i.e. object detection and recognition in an industrial environment. An object 210 in the field of view of the system is shown on display 200 and may include a nut 215 to be tightened by the wearer. The nut may also be referred to as a second object. The objects may be visible in full or part of a video image captured by the cameras in system 100. In one embodiment, a wrench 220 is to be used by the wearer to tighten or loosen the nut 215 per instructions, which may be displayed at 222. A graphical symbol, such as an arrow 225 is provided on the display and is located proximate to the wrench to help the wearer find the wrench 220. Arrow 225 may also include text to identify the wrench for wearers that are not familiar with tools. Similarly, instructions for using rare, seldomly used tools may be displayed at 222 with text and/or graphics. Similar indications may be provided to identify the nut 215 to the wearer.

In further embodiments, a distance indication 230 may be used to identify the distance of the object 210 from the wearer. In still further embodiments, a reference object 230 of known size, e.g., a virtual ruler scale, to the wearer may be placed near the object 210 with a perspective modified to appear the same distance from the wearer as the object 210, to help the user gauge the distance of the object 210 from the wearer.

In the above embodiments, the information may be derived from the images and objects in the video that is captured by the camera or cameras or from stored memory or via a query on the World Wide Web. Common video analytic methods may be used to identify the objects, and characteristics about the objects as described above. These characteristics may then be used to derive information to be provided that is associated with the objects. An arrow or label placed proximate the object so it is clearly associated with the object by a wearer may be generated. Distance information, a reference symbol, other sensed parameters, such as temperature, or dangerous objects may be identified and provided to the wearer in various embodiments.

FIG. 3 is a flowchart illustrating a method 300 of providing images to a wearer of a near to eye display system. Method 300 includes receiving video images at 310. The system may also receive a voice command or command via the push button interface at 315. The images are received based on a field of view of the system. At 320, the video images are analyzed to perform the functionality as defined by the user. For example, the function may be to identify objects in an industrial scenario. At 330, information is generated as a function of the analysis performed (e.g. analyzed objects). Such information may include different characteristics and even modifications to the view of the object itself as indicated at 340. Multiple video analytics are performed at 340 which were described in earlier embodiments. Analytics include but are not limited to modifying brightness of an object, display text, symbols, distance and reference objects, enhance color and intensity, algorithms for face identification, display of identification information associated with the face, and others. At 350, the information is displayed on a display device of the near to eye display system proximate the identified object. The information may also be sent as an audio message to headphones speaker at 360.

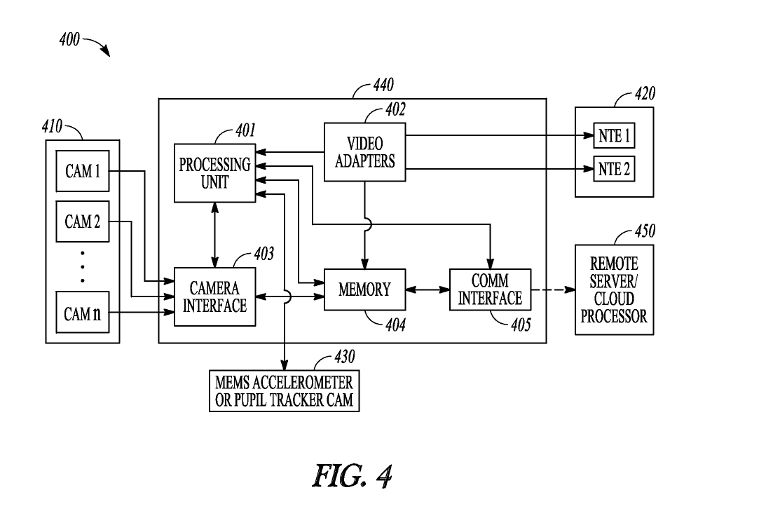

FIG. 4 at 400 shows the hardware components or unit 440 utilized to implement methods described earlier. The unit 440 can be implemented inside the frame containing the cameras and NTE display unit. As such unit 440 becomes a wearable processor unit, which communicates with the cameras and near-to-eye displays either by wired or wireless communication. Unit 440 can also be a remote processing unit which communicates with the other components through a comm interface 405. A processing unit 401 performs video and image processing on inputs from multiple cameras shown at 410. The processing unit 401 may include a system controller including a DSP, FPGA, a microcontroller or other type of hardware capable of executing a set of instructions and a computing coprocessor which may be based on an ARM or GPU based architecture. A computing coprocessor will have the capability to handle parallel image processing on large arrays of data from multiple cameras.

As shown in FIG. 4, block 410 represents a set of cameras which provide the input images. The cameras, which may differ in both the intrinsic and extrinsic parameters, are connected to a camera interface 403. In one embodiment, camera interface 403 has the capability to connect to cameras with multiple different video configurations, resolutions, video encode/decode standards. Along with the video adapters 402, the camera interface block may utilize the processing capabilities of 401 or may have other dedicated processing units. Further, the processing unit, video adapters and cameras will have access to a high speed shared memory 404, which serves as temporary buffer for processing or storing user parameters and preferences.

Embodiments of the system 400 can include a sensor subsystem 430 consisting of MEMS accelerometer and/or pupil tracker camera. The sensor subsystem will have the capability to use the processing unit 401 and the memory 404 for data processing. The outputs from sensor subsystem 430 will be used by the processing unit 401 to perform corrective transformations as needed. Other embodiments of the system also include a communications interface block, 405 which has the ability to use different wireless standards like 802.11 a/b/g/n, Bluetooth, Wimax, NFC among other standards for communicating to a remote computing/storage device 450 or cloud offloading high computation processing from 801. In one embodiment, block 440 is co-located with the NTE displays unit 420, and the block 450 is designed to be a wearable processor unit.

A block 420 consists of near-to-eye (NTE) display units which are capable of handling monocular, binocular or 3D input formats from video adapter 402 in 440. The NTE units may be implemented using different field of view and resolutions suitable for the different embodiments stated above.

### EXAMPLES

1. A method comprising:

receiving video images based on fields of view of a near to eye display system;

applying video analytics to enhance the video images and to identify regions of interest (ROI) on the video images;

generating user assistance information as a function of at least one characteristic of the regions of interest; and

augmenting the enhanced video with the derived information proximate to corresponding regions of interest via visual displays and audio of the near to eye display system.

2. The method of example 1, wherein the user assistance information displayed on the near to eye display system is derived from:

interactive video analysis and user inputs from voice and signals from hand held devices;

information stored in memory; and

information retrieved from cloud storage and the World Wide Web.

3. The method of example 2, wherein the user assistance information comprises images, video clips, text, graphics, symbols including use of color, transparency, shading, and animation.

4. The method of example 2 or 3, wherein the user assistance information is communicated to the user as audio, including

descriptions of the video images, identified regions of interest and their characteristics; and

pre-recorded audio instructions, based on outputs of the video analysis.

5. The method of any one of examples 1-4 wherein the at least one characteristic of regions of interest are selected from the group consisting of textural, spatial, structural, temporal and biometric features including appearance, shape, object identity, identity of person, motion, tracks, and events.

6. The method of example 5 wherein the events further comprise application specific activities, industrial operations including identifying tools, determining a stage of an activity, operation, and the status of a stage.

7. The method of any one of examples 1-6 wherein the video analytics to enhance the video images includes modifying the appearance, brightness and contrast by color and local intensity corrections on pixels in the images.

8. The method of any one of examples 1-7 wherein characteristics of regions of interest further comprise estimated distance to the region of interest, a surface descriptor, and 3D measurements including at least one of volume, surface areas, length, width and height.

9. The method of example 8 wherein the user assistance information is displayed adjacent the corresponding region of interest in the video.

10. The method of example 9 wherein augmenting user assistance information further includes:

a distance scale indicating the projected distances of the pixels from the near to eye display system; and

a geometric object of same size as the corresponding region of interest, proximate the ROI.

11. A multi-media visual system comprising:

near-to-eye displays supported by a frame adapted to be worn by a user such that each display is positioned proximate an eye of the user;

speakers coupled to deliver audio of user assistance information;

a set of cameras supported by the frame, capturing video images of a scene in a field of view;

a microphone receiving inputs from the wearer;

a processor coupled to receive images from the cameras and adapted to apply video analytics to enhance the video images, to identify regions of interest (ROI) on the video images and to generate user assistance information as a function of the characteristics of the regions of interest.

12. The multi-media visual system of example 11 wherein the near to eye display consists of a transparent LCD for text display overlaid on LCD/LCoS/Light-Guide-Optics (LOE) for video display.

13. The multi-media visual system of any one of examples 11-12 wherein the cameras are receptive to different spectra including visible, near infrared (NIR), ultraviolet (UV), short wave infrared bands, mid wave infrared or long wave infrared.

14. The multi-media visual system of any one of examples 11-13 and further comprising:

a MEMS accelerometer to provide orientation of the frame;

cameras capturing images of the eyes of the user including pupil position; and

remote input devices to receive requests from the wearer.

15. The multi-media visual system of example 14 wherein the processor is further adapted to generate user assistance information based on inputs representing the frame orientation, pupil locations and user requests.

16. The multi-media visual system of example 15 wherein user assistance information comprises:

at least one of textural, spatial, structural, temporal and biometric features including appearance, shape, object identity, identity of person, motion, tracks, and events; and

at least one of application specific activities, industrial operations including identifying tools, determining the stage of the activity, operation, and the status of the stage

17. The multi-media visual system of example 16 wherein user assistance information further includes at least one of estimated distance to the region of interest, its surface descriptor, and 3D measurements including volume, surface areas, length, width, and height.

18. The multi-media visual system of example 17 wherein the user assistance information is displayed proximate the corresponding region of interest in the video.

19. The multi-media visual system of example 18 wherein the user assistance information further comprises:

a distance scale indicating the projected distances of the pixels from the near to eye display system; and

a geometric object of same size as the corresponding region of interest, proximate the ROI.

20. The multi-media visual system of example 19 wherein the video analytics to enhance the video images includes at least one of modifying the appearance, brightness and contrast by color, and local intensity corrections on the pixels in the images.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
receiving video images based on fields of view of a near to eye display system;
applying video analytics to enhance the video images and to identify regions of interest (ROI) on the video images;
generating user assistance information as a function of at least one characteristic of the regions of interest; and
augmenting the enhanced video with the derived information proximate to corresponding regions of interest via visual displays and audio of the near to eye display system.

2. The method of claim 1, wherein the user assistance information displayed on the near to eye display system is derived from:
interactive video analysis and user inputs from voice and signals from hand held devices;
information stored in memory; and
information retrieved from cloud storage and the World Wide Web.

3. The method of claim 2, wherein the user assistance information comprises images, video clips, text, graphics, symbols including use of color, transparency, shading, and animation.

4. The method of claim 2, wherein the user assistance information is communicated to the user as audio, including:
descriptions of the video images, identified regions of interest and their characteristics; and
pre-recorded audio instructions, based on outputs of the video analysis.

5. The method of claim 1 wherein the at least one characteristic of regions of interest are selected from the group consisting of textural, spatial, structural, temporal and biometric features including appearance, shape, object identity, identity of person, motion, tracks, and events.

6. The method of claim 5 wherein the events further comprise application specific activities, industrial operations including identifying tools, determining a stage of an activity, operation, and the status of a stage.

7. The method of claim 1 wherein the video analytics to enhance the video images includes modifying the appearance, brightness and contrast by color and local intensity corrections on pixels in the images.

8. The method of claim 1 wherein characteristics of regions of interest further comprise estimated distance to the region of interest, a surface descriptor, and 3D measurements including at least one of volume, surface areas, length, width and height.

9. The method of claim 8 wherein the user assistance information is displayed adjacent the corresponding region of interest in the video.

10. The method of claim 9 wherein augmenting user assistance information further includes:
a distance scale indicating the projected distances of the pixels from the near to eye display system; and
a geometric object of same size as the corresponding region of interest, proximate the ROI.

11. A multi-media visual system comprising:
near-to-eye displays supported by a frame adapted to be worn by a user such that each display is positioned proximate an eye of the user;
speakers coupled to deliver audio of user assistance information;
a set of cameras supported by the frame, capturing video images of a scene in a field of view;
a microphone receiving inputs from the wearer; and
a processor coupled to receive images from the cameras and adapted to apply video analytics to enhance the video images, to identify regions of interest (ROI) on the video images and to generate user assistance information as a function of the characteristics of the regions of interest.

12. The multi-media visual system of claim 11 wherein the near to eye display consists of a transparent LCD for text display overlaid on LCD/LCoS/Light-Guide-Optics (LOE) for video display.

13. The multi-media visual system of claim 11 wherein the cameras are receptive to different spectra including visible, near infrared (NIR), ultraviolet (UV), short wave infrared bands, mid wave infrared or long wave infrared.

14. The multi-media visual system of claim 11 and further comprising:
a MEMS accelerometer to provide orientation of the frame;
cameras capturing images of the eyes of the user including pupil position; and
remote input devices to receive requests from the wearer.

15. The multi-media visual system of claim 14 wherein the processor is further adapted to generate user assistance information based on inputs representing the frame orientation, pupil locations and user requests.

16. The multi-media visual system of claim 15 wherein user assistance information comprises:
at least one of textural, spatial, structural, temporal and biometric features including appearance, shape, object identity, identity of person, motion, tracks, and events; and
at least one of application specific activities, industrial operations including identifying tools, determining the stage of the activity, operation, and the status of the stage

17. The multi-media visual system of claim 16 wherein user assistance information further includes at least one of estimated distance to the region of interest, its surface descriptor, and 3D measurements including volume, surface areas, length, width, and height.

18. The multi-media visual system of claim 17 wherein the user assistance information is displayed proximate the corresponding region of interest in the video.

19. The multi-media visual system of claim 18 wherein the user assistance information further comprises:
a distance scale indicating the projected distances of the pixels from the near to eye display system; and
a geometric object of same size as the corresponding region of interest, proximate the ROI.

20. The multi-media visual system of claim 19 wherein the video analytics to enhance the video images includes at least one of modifying the appearance, brightness and contrast by color, and local intensity corrections on the pixels in the images.
